(19) United States
(12) Patent Application Publication
(10) Pub. No.: US 2024/0366975 A1
(43) Pub. Date: Nov. 7, 2024

(54) ROPING HARNESS AND METHOD FOR MANUFACTURING ONE SUCH ROPING HARNESS

(71) Applicant: ZEDEL, Crolles (FR)

(72) Inventors: Loïc BLONDEAU, La Tronche (FR); Benoit Roger, Saint Prancasse (FR); Sébastien Petzl, Sassenage (FR)

(73) Assignee: ZEDEL, Crolles (FR)

(21) Appl. No.: 18/652,954

(22) Filed: May 2, 2024

(30) Foreign Application Priority Data
May 5, 2023 (FR) 2304504

(51) Int. Cl. A62B 35/00; D03D 15/37

(52) U.S. Cl. CPC A62B 35/0012; A62B 35/0025; D03D 15/37

(57) ABSTRACT

A harness comprises a woven layer shaped as a ring to form a belt or a leg loop. The woven layer comprises first and second yarns woven to form a weave extending from one longitudinal end to the other. The first and second yarns respectively join the two ends and the two transverse edges. The woven layer presents a longitudinally offset broad portion and narrow portion. The woven layer has at least one fold defining a fold line extending mainly in the first direction to form the narrow portion, with a support portion and an overlap portion folded onto the support portion. The overlap portion and support portion have common first yarns and second yarns.

### BACKGROUND OF THE INVENTION

The invention relates to a roping harness and to a method for manufacturing one such harness.

### PRIOR ART

In the field of working at heights, it is known to use a roping harness that has a belt and a pair of leg loops. The roping harness is generally provided with an adjustment system that is configured to adjust the circumference of the belt or of the leg loop.

In conventional manner, the adjustment system is formed by two elements that are commonly an adjustment buckle and an adjustment webbing. The adjustment webbing passes through the adjustment buckle and is blocked so as to define the value of the circumference. The two elements of the adjustment system are connected to one another by one or more resistance straps that provide the mechanical strength of the ring in the event of a fall.

It is known to manufacture a belt or a leg loop with a single webbing having a large constant width. The greater the width of the webbing, the lower the pressure between the webbing and the user in case of a fall, thereby reducing the risks of injury. However, the use of a webbing of large constant width is not very practical and/or is not very comfortable, since a trade-off has to be found between size and contact surface. The stiffness of the webbing limits user comfort.

To enhance user comfort, a comfort foam can be installed between the webbing and the user. The comfort foam extends over almost all of the circumference of the belt to join the two elements of the adjustment system. The width of the webbing is defined to withstand the forces of the fall. The webbing is arranged substantially in the middle of the width of the comfort foam. The comfort foam distributes the pressure force applied by the webbing on the user's body. A good trade-off has to be found between the width of the webbing and the characteristics of the comfort foam, that are in particular the width, thickness and flexibility, in order to provide a good comfort when the harness is donned. An embodiment is illustrated in the document EP0736310.

To improve the comfort of the harness belt, the single webbing has been replaced by two webbing straps of smaller widths that enable the distribution of the forces applied by the belt on the user to be modified in case of a fall. There again, a trade-off has to be found between the width of the two straps and their spacing to provide an acceptable comfort or a good comfort. As an alternative, the webbing is divided in two as illustrated in the document EP2383018. The webbing can be divided in two in the lengthwise direction or a second webbing is fixed above a first webbing in the thickness direction.

In an alternative embodiment illustrated in the document WO2005/000413, it is proposed to use a webbing of variable width along the circumference of the belt. The width is reduced in the area that interacts with the adjustment system so as to reduce the size in the front part of the harness. Due to its manufacturing method, the width modifications are applied in symmetrical manner in the longitudinal direction of the webbing making it difficult to produce a webbing having a suitable shape to form an ergonomic belt or leg loop.

These problematic issues are particularly present in climbing harnesses where the user may remain suspended in his harness for a long time, meaning that the harnesses therefore have to present a greater degree of comfort. The gain in comfort is obtained by the use of a comfort foam, which results in a larger volume.

To improve comfort, it has been proposed to use thin webbings or cords made from strong material that are arranged in substantially homogeneous manner over the whole width of a comfort foam or of a moderately stiff textile support. The webbings are fixed to the support that defines the belt so that, in case of a fall, the forces undergone by the multiple straps/cords are transferred in more homogeneous manner to the user's body by means of the textile support. However, although this configuration gives good results, this configuration is lengthy to implement and onerous, as the multiple straps/cords have to be arranged on the textile support and then secured according to a predefined pattern so that the tensioning of the straps/cords is substantially identical over the whole surface of the comfort foam in case of a fall, i.e. over the whole width of the webbing.

According to another embodiment illustrated in the document EP1834543, the belt is formed by a webbing and the weft thread is eliminated in a portion of the webbing to release the warp threads with respect to one another in the direction perpendicular to the longitudinal axis of the warp threads. The warp threads are spaced apart from one another to increase the width of the belt locally. The warp threads are blocked with respect to one another by means of a support, by bonding or by stitching. This configuration is onerous and the support means reduces the compactness performances.

It has also been proposed in the document FR3007994 to produce a roping harness the belt of which is made in the form of a blanket or a webbing by laser cutting of the latter. The laser cutting step enables more or less large areas to be formed to define a belt having a shape that is better suited to the morphology of a user by means of lumbar support areas, hip support areas and thinner ends for attachment of the adjustment system. However, it is apparent that the mechanical performances of such an architecture are low, as the transverse edges do not withstand any force in case of a fall.

Document EP0736310 discloses a roping harness whose thigh loops are formed by straps provided with a fold that extends from one end to the other end along the longitudinal direction of the strap. The folded zone has a constant width over the entire length of the strap. The folded zone forms a zone with two thicknesses of webbing. The folded zone is a more rigid zone. Outside the folded zone, i.e. in the single-thickness zone, the strap has a variable width, with a few wires extending from one end to the other and all the other wires being mechanically inactive as they do not extend continuously over the entire length of the strap. The technical result is substantially identical to that of FR3007994.

### OBJECT OF THE INVENTION

One object of the invention consists in providing a roping harness that presents a better trade-off between size and comfort while remaining easy to implement.

According to one feature of the invention, the roping harness comprises a belt, a pair of leg loops, a woven layer in the form of a ring to form either the belt or a leg loop, and a closure fixed to a first end and to an opposite second end of the woven layer to close the ring.

The woven layer comprises first yarns and second yarns woven together to form a weave extending seamlessly from the first end to the opposite second end in a first direction, the first yarns extending continuously from the first end to the second end to provide a mechanical strength of the ring whereas the second yarns extend in the second direction.

The woven layer presents a broad portion having a larger width than a narrow portion, the broad portion and narrow portion being offset in the first direction, the width being measured in the second direction.

The roping harness is remarkable in that the woven layer has at least one fold defining a fold line extending mainly in the first direction to form the narrow portion, the fold comprising a support portion and an overlap portion folded onto the support portion; in that the overlap portion and support portion each have first yarns and in that the overlap portion and support portion have common second yarns.

In advantageous manner, the overlap portion and the support portion have common first yarns.

In a particular configuration, the belt or the leg loop has a thicker first end than a central area, the central area being arranged between the opposite first and second ends in the first direction, the thickness being measured perpendicularly to the first direction and the second direction, the belt and the leg loop having an inner face designed to be in contact with the user and an opposite outer face.

In an advantageous development, the fold line defines an angle of less than 30° with respect to the first direction.

Preferentially, the overlap portion covers at least 50% of the width of the support portion, the width extending from the first edge to the second edge.

According to one embodiment, the overlap portion covers 100% of the width of the support portion.

In an advantageous development, the first yarns of the overlap portion and the first yarns of the support portion are misaligned.

Preferentially, the narrow portion has at least one seam defining the misalignment between the first yarns.

In another advantageous development, the closure is chosen from an adjustment system connected to the first and second ends of the woven layer and configured to close and adjust the circumference of said ring, or an opening-closing system connected to the two ends of the woven layer and configured to open and close the ring.

Preferentially, the closure is an adjustment system comprising a first webbing part and a second buckle part, the first webbing part comprising a strap designed to be inserted in a buckle of the second buckle part and wherein the narrow portion forms the strap, the first yarns being inserted in the buckle.

In advantageous manner, the closure is an adjustment system comprising a first webbing part and a second buckle part, the first webbing part comprising a strap designed to be inserted in a buckle of the second buckle part, and wherein the narrow portion forms a wire element attaching the buckle, the first yarns passing round a portion of the buckle to attach the buckle to the woven layer.

It is a further object of the invention to provide a method for manufacturing a roping harness that is easy to implement while enabling a harness to be formed having a better trade-off between comfort and compactness.

This result tends to be achieved by means of a method for manufacturing a roping harness comprising the following steps:
providing a woven band that comprises first yarns woven with second yarns to form a weave, the first yarns extending in the first direction, the second yarns extending in the second direction, the woven band presenting a thickness;
cutting the woven band to a predefined shape to define a woven layer designed to form a belt or a leg loop of a roping harness, the weave extending seamlessly from the first end to the second end in the first direction and from a first edge to a second edge in the second direction, each first yarn extending continuously in the first direction from the first end to the second end to achieve a mechanical continuity, the second yarns extending continuously from the first edge to the second edge, in which each second yarn mechanically joins all the first yarns in the second direction;
folding a part of the woven layer so as to form a broad portion and a narrow portion, the broad portion and the narrow portion being woven and offset in the first direction, the width being measured in the second direction, the narrow portion being obtained by folding with at least one fold line extending mainly in the first direction, the narrow portion having at least two thicknesses of woven layer, the two thicknesses of woven layer being mechanically joined by a continuity of the first yarns and second yarns.

Preferentially, forming the closure involves forming an adjustment system comprising a first webbing part and a second buckle part respectively located at the first and second ends of the woven layer and configured to adjust the circumference of said either the belt or a leg loop, each first yarn extending continuously in the first direction from the first webbing part to the second buckle part to achieve a mechanical continuity. The first yarns of two thicknesses of the narrow portion extend up to the first webbing part.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a harness;

FIG. 2 schematically illustrates a perspective view of a particular embodiment of a harness;

FIG. 3 schematically illustrates an elevational view of a woven layer designed to form a belt according to one of the embodiments;

FIG. 4 schematically illustrates an elevational view of a particular portion of the woven layer;

FIG. 5 schematically illustrates an elevational view of a particular portion of the woven layer illustrated in FIG. 4 after folding;

FIG. 6 schematically illustrates an elevational view of a particular portion of the woven layer illustrated in FIG. 4 with several areas having different mechanical characteristics;

FIG. 7 schematically illustrates a band designed to be cut to form one or more woven layers representing a belt or a leg loop.

### DESCRIPTION OF THE EMBODIMENTS

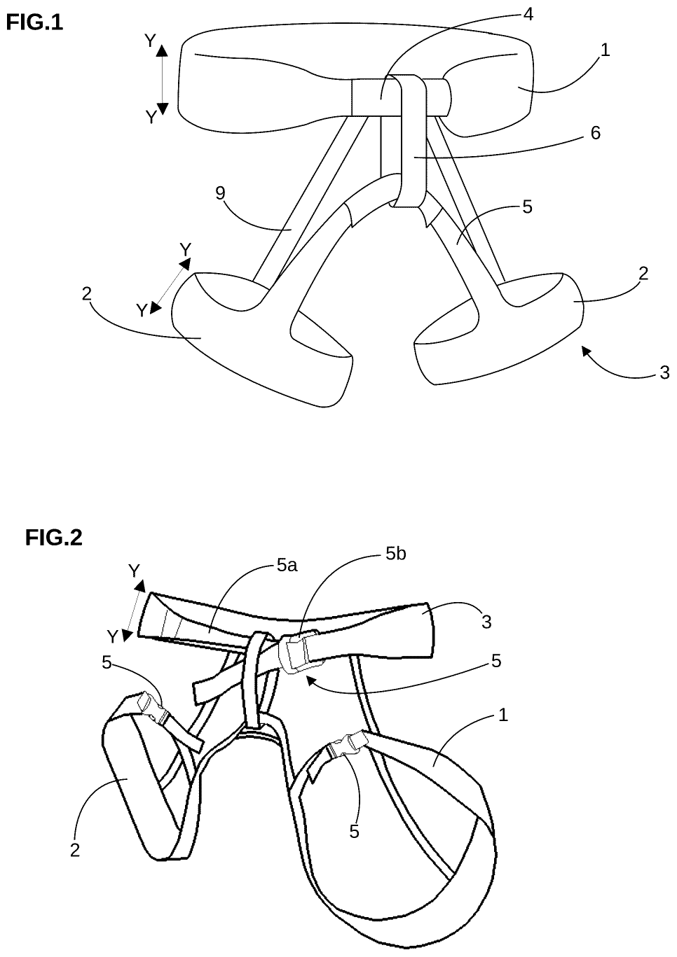

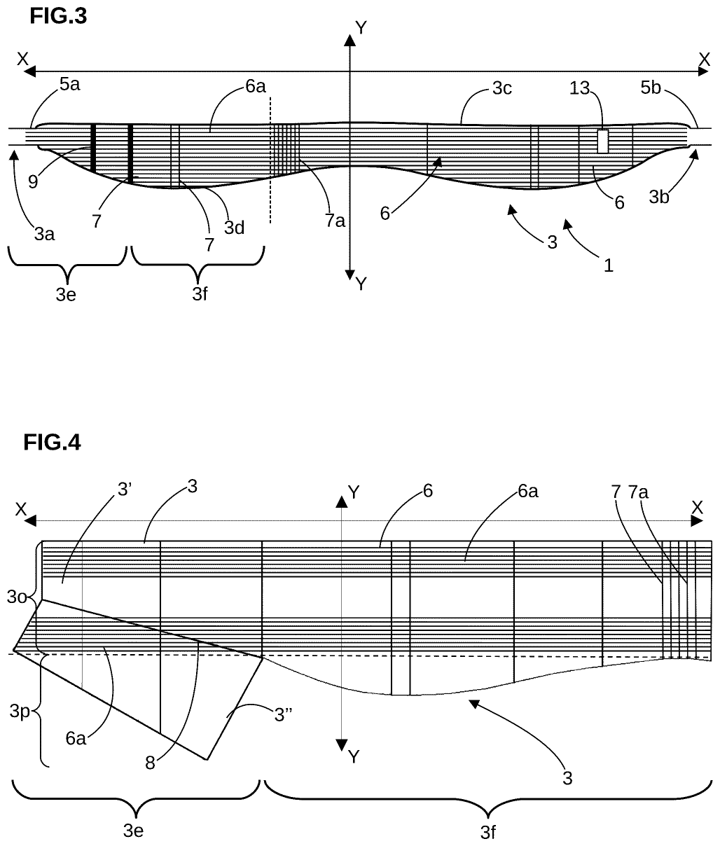

FIGS. 1 to 7 illustrate different embodiments of a roping harness that comprises a belt 1 and a pair of leg loops 2. As illustrated in FIGS. 1 and 2, the harness also comprises a woven layer 3 arranged in the form of a ring and designed to form either the belt 1 or a leg loop 2. The ring is closed by means of a closure 4. The closure 4 is arranged fixedly at a first end 3a and at a second end 3b of the ring. The first end 3a and the second end 3b are opposite one another in a first direction XX.

Depending on the embodiments, the closure 4 is chosen from an adjustment system 5 configured to adjust the circumference of the woven layer in the form of a ring, or an opening-closing system configured to open and close the ring or a seam that keeps the two ends of ring securedly in place. FIG. 2 illustrates different adjustment systems that are also opening-closing systems.

The adjustment system 5 preferentially comprises a first part and a second part that cooperate with one another to adjust the circumference of the ring. Advantageously, the first part is a first webbing part 5a and the second part is a second buckle part 5b. The second buckle part 5b has a buckle that is passed through by a strap of the first webbing part 5a to adjust the circumference. The first webbing part 5a and the second buckle part 5b are arranged fixedly at each of the ends of the woven layer 3 in the first direction XX. The strap of the first webbing part 5a is secured in the buckle of the second buckle part 5b to set the circumference of the ring. The opening-closing system is associated with the woven layer 3 in the same way with a first part fixed to the first end 3a and a second part fixed to the second end 3b.

The woven layer 3 comprises longitudinal yarns 6 and transverse yarns 7 woven together to form a weave. The longitudinal yarns 6 extend in the first direction XX whereas the transverse yarns 7 extend in a second direction YY perpendicular to the first direction XX. The weave extends seamlessly from the first end 3a to the opposite second end 3b in the first direction XX. The weave extends seamlessly from the first edge 3c to the opposite second edge 3d in the second direction YY.

The longitudinal yarns 6 comprise first yarns 6a. Each first yarn 6a extends continuously in the longitudinal first direction XX from the first end 3a to the opposite second end 3b to provide the required mechanical strength of the belt 1 or of the leg loop 2 in the event of a fall. The first yarns 6a are fixed to the closure to ensure the mechanical integrity of the ring in the closed position in case of a fall.

The transverse yarns 7 comprise second yarns 7a extending in the second direction YY. The second yarns 7a extend continuously from the first edge 3c to the opposite second edge 3d in the second direction YY and they connect the first yarns 6a, preferably all the first yarns 6a.

The woven layer 3 comprises the first yarns 6a and second yarns 7a that are interwoven to provide the required mechanical performances in the first direction XX and the second direction YY. In advantageous manner, the woven layer 3 has a first area where the woven longitudinal yarns 6 are only first yarns 6a. The first woven area extends continuously in the second direction YY. Preferentially, the first woven area is unique, i.e. all the first yarns 6a are included in the first area. The first woven area is formed solely by the first yarns 6a thereby providing the strength of the woven layer 3 in the first direction XX in case of a fall to ensure the integrity of the ring.

The first yarns 6a may only comprise identical or substantially identical resistance yarns to ensure that a predefined mechanical strength is obtained in the first direction XX. As an alternative, the first yarns 6a can comprise yarns having different mechanical strengths in order to achieve a better trade-off between the mechanical strength and the surface occupied by the first yarns 6a in the second direction YY. The nature of the first yarns 6a and the cross-sections of the latter are defined so as to obtain the required mechanical performance in the first direction XX. Advantageously, all the first yarns 6a are identical.

To improve the comfort when the user is suspended in his harness, it is advantageous to have a mechanically active contact surface that is as large as possible in order to place a load on a large number of first yarns 6a. However, the width of the harness cannot be increased too greatly so as not to penalise the comfort when not in suspension situations, the weight and if applicable the compressibility of the latter.

The woven layer 3 has a thickness that is defined by the diameters of the yarns used and the weave or weaves applied.

The woven layer 3 preferentially presents a broad portion 3f and a narrow portion 3e, the broad portion 3f having a larger width than the narrow portion 3e. The broad portion 3f and the narrow portion 3e are woven. The broad portion 3f and the narrow portion 3e are offset in the first direction XX. The width is measured in the second direction YY. The variation of width of the woven layer 3 enables the shape of the belt 1 or of the leg loop 2 to be better adjusted to match the user's morphology. The seamless weave in the XX and YY directions results in a better pressure distribution when the user is suspended. It is preferable to have a broad portion 3f in the dorsal part of the belt 1 or in the rear part of the leg loops 2. A narrow portion 3e is on the other hand preferred in the abdominal part so as not to hamper a user when he bends forwards. The front part of the leg loops 2 can also be associated with a less broad portion as the strain take-up is moderate. This adaptation of shapes enables the harness to be lightened.

To withstand high stresses in the event of a fall, a large number of the first yarns 6a are sought to be stressed. In the prior art configurations, such a result is obtained using a single large-width strap. The broader the strap, the larger the number of the first yarns 6a to be stressed. The width is much larger than what is necessary to withstand fall loads, but enables the pressure forces on the user to be reduced. In return however, the adjustment system is bulkier.

To provide a woven layer 3 that presents a better trade-off between the strength in the first direction XX and the comfort represented by the width in the second direction YY, the woven layer 3 preferentially has at least a narrow portion 3e and a broad portion 3f. The narrow portion 3e is formed by at least one fold. The fold is defined by a fold line 8 that represents a boundary of narrow portion 3e where the woven layer 3 is folded onto itself. The fold line 8 extends mainly in the first direction XX so as to make the first yarns 6a work efficiently in case of a fall. Preferentially the fold line 8 also has a component in the second direction YY.

When the fold line 8 is parallel to the second direction YY or almost parallel to the second direction YY, the mechanical stressing of the folded area makes the two portions of first yarns 6 arranged on each side of the fold work differently.

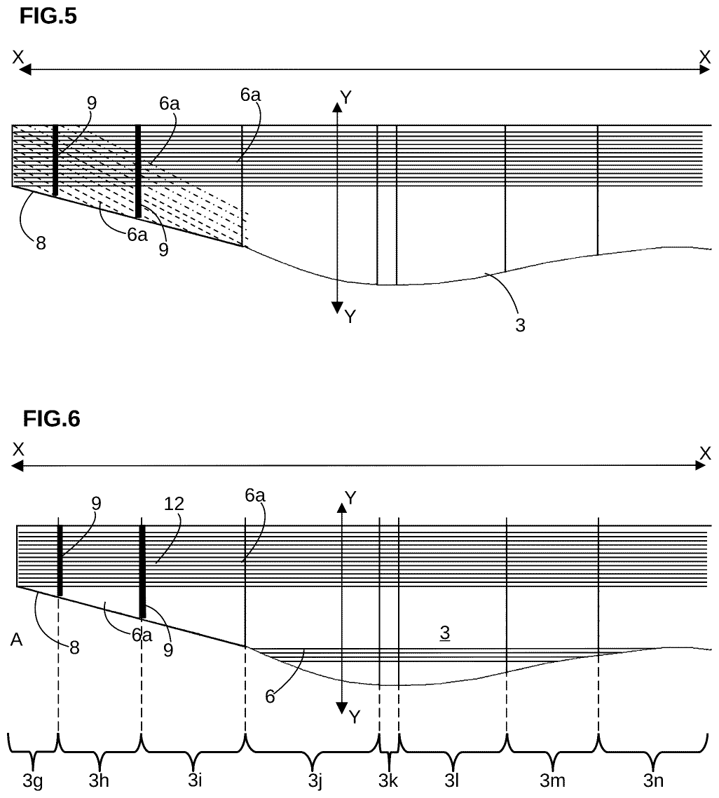

The folded area is formed from the woven layer 3 which defines a support portion 3′ and an overlap portion 3″ as illustrated in FIG. 4. The overlap portion 3″ is folded onto the support portion 3′ as illustrated in FIG. 5. The support portion 3″ and the overlap portion 3′ have one or more first yarns 6a in common. Overlapping of the support portion 3′ by the overlap portion 3″ makes it possible to keep the number of the first yarns 6a while at the same time reducing the effective width of the woven layer 3 that will be stressed in case of a fall. By folding and increasing the thickness locally, it is possible to make a large number of first yarns 6a work as is the case in the dorsal part of the belt 1 or the rear part of the leg loop 2.

The overlap portion 3″ and the support portion 3′ have the second yarns 7a in common thereby enabling a better transfer of forces to be had in the folded part. The use of common first yarns 6a and common second yarns 7a between the overlap portion 3″ and the support portion 3′ ensures a better force transfer.

The use of first yarns 6a that connect the two ends 3a and 3b and that pass through broad portion 3f and narrow portion 3e makes it possible to provide a woven layer 3 that adapts better to suit the user's morphology while being able to have a large number of first yarns 6a. The broad portion 3f and the narrow portion 3e have an identical number of the first yarns 6a. The second yarns 7a that connect the two thicknesses ensure a good transfer of forces between the two folded layers whereas the two thicknesses provide a greater stiffness. It is advantageous for the number of yarns/cm to be constant from the first end to the second end, for each given group of consecutive first yarns, for example at least ten first yarns. It is also advantageous for the number of yarns/cm in the portion containing the first yarns to be constant from one edge to the other in the YY direction.

Increasing the thickness makes it possible to have a local increase of the stiffness of the woven layer 3 which may be advantageous in proximity to an adjustment system or an opening-closing system for ease of use of the latter, in particular when wearing gloves.

The narrow portion 3e and the broad portion 3f are passed through by the same number of the first yarns 6a. They present the same or substantially the same mechanical performances in the first direction XX. The distribution of the first yarns 6a over at least two thicknesses of the woven layer 3a enables a large number of first yarns 6a to be used thereby making it possible to reduce the cross-section of the first yarns 6a and/or to reduce the thickness of the comfort foam. In a particular case, the belt 1 and/or the leg loop 2 is devoid of comfort foam. Reducing the cross-section of the yarns enables the flexibility of the woven layer 3 to be improved.

Folding is an operation that is simple to perform and well mastered thereby enabling a roping harness to be formed economically.

In preferential manner, the longitudinal yarns 6 comprise first yarns 6a and also additional first yarns 6b. The additional first yarns 6b do not extend continuously from the first end 3a to the second end 3b and/or they are not secured to the closure 4, at least at one of their ends. The additional first yarns 6b are joined to the first yarns 6a by the second yarns 7a to ensure a mechanical cohesion from the first edge 3c to the second edge 3d.

In case of a fall, the additional first yarns 6b are not stressed as much as the first yarns 6a and cannot serve the purpose of ensuring the mechanical integrity of the harness. The additional first yarns 6b are woven with the second yarns 7a so as to form at least one woven area that extends beyond the first yarns in broad portion 3f. This at least one woven area enables user comfort to be enhanced by taking up the forces slightly and by increasing the contact area with the user.

The additional first yarns 6b are preferentially made from a different material from the material forming the first yarns 6a. In preferential manner, the first yarns 6a form a single area extending continuously in the second direction YY. The additional first yarns 6b form one or two woven areas on one side or on both sides of the area constituted by the first yarns 6a in the second direction YY.

In preferential manner, the fold line 8 defines an angle of less than 30° with the first direction XX. More preferentially, the fold line 8 defines an angle of less than 20°. The smaller the angle, the closer the behaviours are between the folded first yarns 6a and the non-folded first yarns 6a. Advantageously, the fold line 8 defines an angle at least equal to 5° to achieve a good trade-off between the length of the narrow portion 3e in the first direction XX and the overlap portion 3″ in the second direction YY.

In preferential manner, each first yarn 6a is discontinuous from the other first yarns 6a and each second yarn 7a is discontinuous from the other second yarns 7a. In other words, the first yarns 6a and the second yarns 7a are not formed by a single yarn. The first yarns 6a and the second yarns 7a are cut at their two terminations. The second yarns 7a provide the transverse mechanical link between the first yarns 6a by mechanically connecting all the first yarns 6a and more preferentially all the longitudinal yarns 6.

The woven layer 3 can be formed by cutting a fabric or a webbing, for example by laser cutting. The fabric or webbing has warp and weft yarns that are woven together in a predefined two-dimensional or three-dimensional layout. The fabric or webbing is then cut according to a predetermined pattern to form the woven layer 3 with the correct positioning of the first yarns 6a, and of the additional first yarns 6b if applicable.

After the fabric or webbing has been cut, the first yarns 6a are independent from one another in response to a pin-point stress in the longitudinal direction XX. The second yarns 7a are independent from one another in response to a pin-point stress in the second direction YY. Cutting of the initial material to form the woven layer 3 may make it impossible to determine which yarn is a weft yarn and which yarn is a warp yarn.

The independence of the second yarns 7a in the second direction YY results in a greater flexibility of the woven material in comparison with a fabric where the first yarns 6 or the second yarns 7 correspond to one and the same yarn.

It is advantageous for the narrow portion 3e to present a width that is smaller than the width of the broad portion 3f by at least 30%. In a particular embodiment illustrated in FIGS. 4 and 5, a narrow portion 3e is formed by a single fold of the woven layer 3. It is possible to provide for the narrow portion 3e or another narrow portion 3e to be formed by two folds with two fold lines 8. The choice between a single fold line 8 or two fold lines 8 depends on the shape of narrow portion 3e and on the ease of making the cuts and folds.

The narrow portion 3e formed by at least one fold makes it possible to have a part of the woven layer 3 that overlaps another part of the woven layer 3 in the thickness direction that is perpendicular to the first direction XX and to the second direction YY. For the first yarns 6a to work well, it is advantageous for the first yarns 6a of the two thicknesses of the narrow portion 3e to be misaligned as illustrated in FIG. 5. The narrow portion 3e has at least one seam 9 that defines the misalignment between the first yarns 6a. In other words, it is not advantageous to want to make a second fold in the continuity of the first fold for the first yarns 6a to be arranged parallel to one another. The two consecutive folds near one another in the first direction XX will create a dissymmetry in the forces applied between the different first yarns 6a.

In a particularly advantageous configuration, the narrow portion 3e is sufficiently narrow to form a webbing strap that is able to pass through a conventional buckle of an adjustment system 5. This embodiment is particularly advantageous as the first yarns 6a of the woven layer 3 form the strap of the first webbing part 5a, i.e. the part that passes through the buckle and moves inside the buckle to define the circumference of the ring and is secured in the buckle to fix the circumference of the ring.

This embodiment is particularly advantageous as it avoids having to attach a webbing to the end of the woven layer 3 to achieve the mechanical continuity between the woven layer 3 and the first webbing part 5a. Transfer of forces is better applied. The woven layer 3 then forms part of the adjustment system 5.

In a preferential embodiment, the end of the woven layer 3 designed to receive the second buckle part 5b forms a narrow portion 3e. The narrow portion 3e is obtained by at least one fold line. In a particular case, the woven layer 3 is folded so that the width is equal or substantially equal to the width of the webbing supporting the buckle of the second buckle part 5b. In another particular case, the narrow portion 3e forms a wire element such as a strap supporting the buckle of the second buckle part 5b. The wire element forms a ring that is closed. The ring is closed by a seam extending in the second direction YY, for example from one edge to the other. The buckle of the adjustment system 5 is enclosed in the ring. In this particular case, the woven layer 3 forms part of the adjustment system 5. As for the previous configuration, the fold of the woven layer 3 makes it possible to have a large contact surface with the user in the broad portion 3f with a large number of first yarns 6a, for example the dorsal part of the harness, and to keep this large number of first yarns 6a in the adjustment system 5. In proximity to the median sagittal plane, the width of the woven layer 3 decreases so as not to inconvenience the user when he bends forwards.

To achieve a better trade-off between comfort and ease of adjustment, it is advantageous for the two ends of the woven layer 3 to be narrow portions 3e. A first narrow portion 3e is designed for securing or for formation of the strap of the first webbing part 5a and a second narrow portion 3e is designed for fixing the second buckle part 5b or for fixing the buckle. This embodiment is particularly advantageous as it makes it possible to achieve a harness having a reduced weight.

It is particularly advantageous for the folded areas, i.e. the areas where two thicknesses of the woven layer 3 overlap, to be fixed to one another by at least one fastening seam 9. The use of a fastening seam 9 makes it possible to fix the position of the first yarns 6a with respect to one another and to form a stiffer narrow portion 3e. Increasing the stiffness results in a more homogeneous stressing of the first yarns 6a in comparison with an area where the two thicknesses of the woven layer 3 can deform independently from one another.

The roping harness can be manufactured by means of a manufacturing method that is simple and easy to implement.

A band of woven material is provided that comprises longitudinal yarns 6 woven with transverse yarns 7. The woven material comprises at least the first yarns 6a woven with second yarns 7a in one or more predefined weaving patterns. The band can a fabric or possibly a webbing. The first yarns 6a extend in the first direction XX. The second yarns 7a extend in the second direction YY. The band presents a thickness. In preferential manner, a fabric is used, thereby providing a greater freedom as regards the shape and/or definition of the woven areas with different mechanical performances, for example differences in the yarns used or in the weaving pattern used. The use of a fabric enables one or more woven patterns to be formed that are arranged non-symmetrically with respect to the first direction XX or with respect to the second direction YY, which is preferential for forming several patterns representative of a belt 1 and/or a leg loop 2 on one and the same band.

The band is cut to a predefined shape to define a woven layer 3 designed to form a belt 1 or a leg loop 2 of a roping harness. The weave extends continuously from the first end 3a to the second end 3b in the first direction XX and from a first edge 3a to a second edge 3d in the second direction YY. Each first yarn 6a extends continuously in the first direction XX, for example from the first webbing part 5a to the second buckle part 5b, to provide a mechanical continuity. The second yarns 7a extend continuously from the first edge 3c to the second edge 3d.

Each second yarn 7a joins all the first yarns 6a mechanically in the second direction YY and is discontinous from the other second yarns 7a. Each first yarn 6a is discontinous from other the first yarns 6a. Each first yarn 6a preferentially joins all the second yarns 7a.

A part of the woven layer 3 is folded to form a broad portion 3f and a narrow portion 3e. The broad portion 3f and the narrow portion 3e are woven. The broad portion 3f and the narrow portion 3e are offset in the first direction XX. The width is measured in the second direction YY.

Narrow portion 3e is obtained by folding with at least one fold line 8 extending mainly in the first direction XX. The narrow portion 3e has at least two thicknesses of the woven layer 3. The two thicknesses of the woven layer 3 are joined mechanically by a continuity of the first yarns 6a and the second yarns 7a.

A first webbing part 5a and a second buckle part 5b are formed at the two opposite ends of the woven layer 3 in the first direction XX and are configured to adjust the circumference of one of the belt 1 or a leg loop 2. Each first yarn 6a extends continuously in the first direction XX from the first webbing part 5a to the second buckle part 5b to provide a mechanical continuity. The first yarns 6a of two thicknesses of the narrow portion 3e extend from the first webbing part 5a to the second buckle part 5b.

When the band of woven material is formed, the first yarns 6a are woven with the second yarns 7a to form a woven pattern that is representative of a belt 1 or a leg loop 2. The woven pattern is cut, for example by laser cutting, to form the woven layer 3. In preferential manner, the cut pattern comprises the woven portion constituted by the first yarns 6a and the second yarns 7a as well as the additional portions constituted by the additional first yarns 6b and the additional second yarns 7b woven together. The additional first yarns 6b are arranged in parallel manner to the first yarns 6a. The characteristics of the first yarns 6a, their number and the weaving diagram with the second yarns 7a were defined beforehand to withstand a set of stresses representative of a belt 1 or a leg loop 2.

The shape of the woven layer 3 and in particular of the woven pattern constituted by the first yarns 6a and the second yarns 7a is defined by the loom. The shape of the additional patterns constituted by the additional first yarns 6b and the second yarns 7a is made by the same loom. All the patterns are accomplished in a single weaving operation, i.e. by means of a single loom and in a single run.

Depending on the configurations, the first yarns 6a and the second yarns 7a are respectively warp yarns and weft yarns or weft yarns and warp yarns.

Several patterns representative of a belt and/or of a leg loop are made on the same band by means of a single loom in a single weaving operation. The band is then cut so as to delineate several woven layers 3 that are designed to form the belts 1 and/or the leg loops 2. One and the same band can undergo several successive cuts to form different patterns representative of the belts 1 having different lengths and/or widths and/or different patterns representative of leg loops 2 having different lengths and/or widths.

In preferential manner, the woven layer 3 representative of a belt 1 or a leg loop 2 comprises a central strip having only the first yarns 6a in the XX direction and extending mainly in the first direction XX. The pattern preferentially comprises one or more additional areas that extend from the central strip and form at least part of one edge of the woven layer 3.

Once the band has been cut to form the woven layer, a fold is made defining a fold line 8. The fold enables the width of the woven layer 3 to be reduced with a mechanical continuity of the first yarns 6a and the second yarns 7a. The fold or folds reduce the width of the woven layer 3 and enable a constant tensile strength to be had substantially from the first end 3a to the second end 3b.

In preferential manner, a stitching step is performed on the folded area to freeze the positions of the first yarns 6a with respect to one another in the first direction XX for the at least two superposed thicknesses. This makes it possible to have a more uniform deformation between the two thicknesses of the woven layer 3 and therefore to have a more uniform stressing of the first yarns 6a.

In a particular embodiment, the first webbing part 5a comprises a webbing that is stitched to one end of the woven layer 3. The width of the webbing corresponds to the width of narrow portion 3e so as to stress all the first yarns 6a. In another particular embodiment, the second buckle part 5b comprises a webbing that is sewn to one end of the woven layer 3. The width of the webbing corresponds to the width of narrow portion 3e so as to stress all the first yarns 6a. Preferentially, the webbing is fastened by stitching. A stitching yarn passes through the multiple thicknesses of the fabric woven layer 3 in the thickness direction. Stitching of the two folds of woven material enables the position of the two folds to be fixed, thereby enabling the spatial configuration of the first yarns 6a to be fixed.

In a preferential embodiment, the overlap portion 3″ comprises first yarns 6b and additional first yarns 6b and the overlap portion 3″ has an identical shape to that of support portion 3′. The overlap portion 3″ and the support portion 3′ are fixed to one another by stitching yarns 9. Although the overlap portion 3″ has the additional first yarns 6b, full coverage of the support portion 3′ from one edge to the other enables a mechanical functioning of the narrow portion 3e to be obtained.

This configuration is particularly advantageous as it enables a belt 1 or a leg loop 2 to be formed having a large proportion of first yarns 6a compared with the longitudinal yarns 6. The belt 1 or the leg loop 2 can be formed without comfort foam thereby reducing the weight and bulk. The woven layer 3 can be made from a fabric comprising two folds, i.e. with two sets of weft yarns and warp yarns arranged on one another. One fold provides the mechanical strength of the woven layer 3. The other fold forms a protection layer to prevent a direct contact with the first yarns 6a on a face of the woven layer 3.

When the second yarns 7a have a constant diameter between the narrow portion 3e and the broad portion 3f, making a fold enables a woven layer 3 to be formed that is thicker than the broad portion 3f. When the second yarns 7a are identical or substantially identical between the narrow portion 3e and the broad portion 3f, the fold enables the stiffness of the narrow portion 3e to be increased with respect to the broad portion 3f. Increasing the stiffness is particularly advantageous when the first yarns 6a form the webbing strap that passes through the buckle of the adjustment system. This enables a better mastery to be had as regards handling of the strap. If required, the second fold can be formed from a material that has a lower static and/or dynamic friction coefficient than the friction coefficient of the first yarns 6a in order to keep the ring better in the chosen circumference.

To form the narrow portion 3e or an end of the narrow portion 3e, it is also advantageous to choose different second yarns 7a from other second yarns 7a so as to have a lower static and/or dynamic friction coefficient than the static and/or dynamic friction coefficient of the first yarns 6a in order to better keep the ring within the chosen circumference. The second yarns 7a can also be chosen to adjust the stiffness value of the narrow portion 3e or of a part of the narrow portion 3e.

Such embodiments can be used to form the narrow portion 3e designed to receive the second buckle part 5b or to attach the buckle.

As an alternative or as a complement to a woven layer 3 that comprises a narrow portion 3e obtained by folding, it is particularly advantageous to provide a woven layer 3 that has several woven sections arranged consecutively in the first direction XX and/or the second direction YY and that present different technical characteristics. As previously, the woven layer 3 presents a weave extending continuously from the first end 3a to the opposite second end 3b in the first direction XX and from the first edge 3c to the second edge 3d in the second direction YY.

The woven layer 3 comprises the longitudinal yarns 6 and the transverse yarns 7 woven together. The longitudinal yarns 6 comprise the first yarns 6a extending continuously from the first end 3a to the second end 3b to provide a mechanical strength of the ring.

It is particularly advantageous to provide for two adjacent areas of each pair of adjacent areas to present different mechanical properties. The two adjacent areas have common longitudinal or transverse yarns. The difference of mechanical properties between two adjacent areas corresponds to at least one of the characteristics chosen from:
a difference of chemical composition and/or of diameter of the transverse yarns for two adjacent areas offset in the first direction XX,
a difference of chemical composition and/or of diameter of the longitudinal yarns for two adjacent areas offset in the second direction YY,
a difference of thread count pattern of the transverse yarns,
a difference of weaving pattern between the transverse yarns and longitudinal yarns.

In preferential manner, two distinct adjacent areas are arranged consecutively only in the first direction XX or only in the second direction YY. In other words, two distinct adjacent areas share only the longitudinal yarns 6 or only the transverse yarns 7. FIGS. 4 and 6 illustrate a woven layer 3 having different areas arranged behind one another in the first direction XX or in the second direction YY. Areas 3g, 3h, 3i, 3j, 3k, 3l, 3m and 3n are distinct areas arranged behind one another in the first direction XX that can be a weft direction or a warp direction. Areas 30 and 3p are distinct areas arranged behind one another in the second direction YY that can be a warp direction or a weft direction.

The use of at least a first area for example 3g and a second area for example 3h, arranged consecutively in the first direction XX and passed through by the first yarns 6a, enables a good transfer of forces to be had from the first end 3a to the second end 3b while functionalising the woven layer 3, i.e. adapting the mechanical characteristics of the woven layer 3 to deal with specific issues. Functionalisation is achieved by using different second yarns 7a and/or a different weaving pattern between the first area and the second area.

The first area has a first type of second yarns 7a and a first weaving pattern. The second area has a second type of second yarns 7a and a second weaving pattern. The first type of second yarns is different from the second type of second yarns and/or the first weaving pattern is different from the second weaving pattern. For example, the different areas 3g-3n all differ from the adjacent area by a mixture of different second yarns.

The first area differs from the second area by a difference of permeability to water in the thickness direction. The permeability to water is measured by means of a test according to the ISO 2528 standard or according to the EN ISO 12572 standard. The difference of permeability enables perspiration to be better regulated. For example, the portion of broad portion 3j or 3l has a higher permeability to water than area 3g or 3h as it is designed to have a more continuous contact with the body. It therefore has to be able to eliminate perspiration better.

As an alternative or as a complement, the first area differs from the second area by a difference of permeability to air in the thickness direction. The permeability to air is measured by means of a test according to the ISO 9237 standard.

As an alternative or as a complement, the first area differs from the second area by a difference of flexural strength for a force applied in the thickness direction ZZ. The difference of flexural strength enables the comfort of the woven layer to be adjusted.

As an alternative or as a complement, the first area differs from the second area by a difference of thickness which makes it possible to modulate the comfort and therefore to better adjust the mechanical performances to match the user's morphology. It is advantageous to have a difference of thickness between areas 3g and 3h to better adjust the ease of use of the part involved in operating an adjustment device 5 or an opening-closing device.

As an alternative or as a complement, the first area differs from the second area by a difference of elasticity in the second direction YY. The difference of elasticity enables a different movement of the first yarns 6a with respect to one another to be had in the second direction YY depending on the area, thereby enabling the shape of the woven layer to be better adjusted to match the user's morphology. Areas 3h and 3j have different flexibilities in order to better adjust to meet the requirements of the user suspended in his harness.

In preferential manner illustrated in FIG. 6, the woven layer 3 has at least three consecutive areas in the first direction XX. The at least three areas define two areas separated by a hinge area. The weaving and/or the nature of the second yarns in the hinge area is configured to define a preferential flexion in the first direction XX in response to a force in the ZZ direction. The hinge area presents a lower stiffness than the stiffness of the two adjacent areas. For example, area 3k forms a hinge area between areas 3j and 3l.

It is advantageous to provide for the woven layer 3 to have a stiffer area at each end of the woven layer 3. The stiffer area is preferably one of the narrow portions. More preferentially, the two ends of the woven layer 3 are narrow portions 3e. For example, areas 3g and 3h present a greater stiffness than areas 3j, 3k, 3l, 3m and 3n so as to have a greater comfort in the area that is almost continuously in contact with the body and a lesser comfort resulting from a greater stiffness in a portion where the pressure on the body is lesser.

When the woven layer 3 has a folded area, i.e. an area that is formed by two superposed layers of the woven layer 3, it is advantageous for the second yarns 7a of the folded area to be formed by different second yarns from the areas adjacent to the folded area. It is preferable for the folded area to comprise the second yarns 7a that have a greater stiffness. For example, the second yarns used to form areas 3g, 3h and 3i are different from the second yarns 7a used in area 3j and may be different from one another.

In a particular embodiment, the woven layer 3 has an end that is a folded area. The folded area has a stiffer area and a suppler area that are arranged consecutively in the first direction XX. The suppler area is designed to be folded onto itself and fixed by a stitched seam to secure the buckle of the second buckle part 5b or a buckle of an opening-closing device. For example, area 3g uses different second yarns 7a from those of area 3h to enable it be easily folded with respect to a fold line parallel to the second direction YY.

The use of a supple area makes it easier to fold the end of the woven layer 3 that is already a folded layer. There are then four layers of fabric superposed on one another. For example, it is sought to reduce the thickness of area 3g with respect to area 3h.

Functionalisation of the woven layer 3 by adjusting the mechanical performances of the second yarns 7a or the weave enable a woven layer 3 to be provided that presents a small thickness and matches the user's requirements more closely.

Modification of the second yarns 7a to define the at least two areas can be achieved in different ways. The difference of second yarns 7a between the first area and second area can be chosen from a different diameter, a different chemical composition or a different surface state.

In one and the same area, the second yarns 7a can be identical or can present a mix between several yarns of different natures and/or sizes.

In a particular case, the first area is defined by second yarns 7a of a first nature, for example second yarns 7a made from high-resistance polyamide formed by multifilaments, and the second area is defined by a mix of second yarns 7a of a first nature and second yarns 7a of a second nature, for example the second yarns 7a made from high-resistance polyamide and the second yarns 7a of mono-filament type.

The second yarns 7a extending in the second direction YY from the first edge 3c to the second edge 3d, the woven layer 3 defines consecutive transverse areas 3g-3n where a unity of second yarns 7a exists. Two consecutive transverse areas can differ from one another by a difference of chemical composition of the second yarns 7a.

In preferential manner, the weaving pattern is identical from the first edge 3c to the second edge 3d in a given transverse area. Advantageously the thread count is constant for a given transverse area 3g-3n.

The woven layer 3 has a longitudinal area 3o-3p that extends in the first direction XX and presents a unity in the longitudinal yarns 6 used. The woven layer 3 comprises at least a first longitudinal area 30 that is formed by all or part of the first yarns 6a. When the first yarns 6a are identical, the first yarns 6a only define first longitudinal area 30. When the first yarns 6a have two different types of yarns dissociated in the second direction YY to provide two different mechanical behaviours, the first yarns 6a define the first longitudinal area and a second longitudinal area.

In advantageous manner, the woven layer 3 has at least two distinct longitudinal areas 3o and 3p. The second longitudinal area 3p is devoid of the first yarns 6a.

The longitudinal and transverse areas cross one another to define distinct functional areas that have different mechanical characteristics from the immediately adjacent functional area in the first direction XX or in the second direction YY. The use of common longitudinal yarns 6 or common transverse yarns 7 results in a better transfer of forces while being able to adapt the performances of the woven layer 3. This avoids having to add one or more layers on the woven layer 3.

The woven layer 3 is obtained from a woven band that comprises several distinct functional areas. The woven band has weft strips running in the weft direction and/or warp strips running in the warp direction. Preferably, in a warp strip, the thread count of the warp yarns is constant from one end of the warp band to the other, the same warp yarns are present and in the same arrangement. Preferably, in a weft strip, the thread count of the weft yarns is constant from one end of the weft strip to the other, and the same weft yarns are present in the same arrangement. The woven band comprises at least one weft strip and several warp strips, or at least one warp strip and several weft strips.

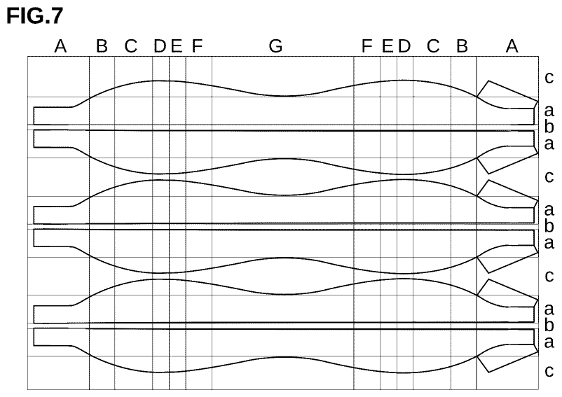

FIG. 7 illustrates a particular embodiment of a woven band designed to form belts 1. The belt patterns are represented to provide a better clarity and correspond to the path taken by the cutting tool to form the woven layer 3.

The warp strips cross the weft strips to define a zone with precise mechanical characteristics that derive from the weft and warp yarns used and the weaving pattern employed. The zone is preferably in the form of a rectangle. The warp and weft yarns are selected and the weaving program of the loom is configured to form the multiple zones of the woven band by means of the different weft and warp strips.

A woven band is formed by means of a loom. The loom weaves the different yarns that form the longitudinal yarns 6 and transverse yarns 7 according to the previously defined program. The woven band has areas that differ from the immediately adjacent areas in the weft direction or the warp direction by at least a difference in the yarns used and/or in the weaving pattern.

The woven band is cut, for example by laser cutting, to form the woven layer 3 that is designed to form a belt or a leg loop. It is even possible to form the two leg loops by means of one and the same band. The band can comprise one or more patterns representative of a belt and/or one or more patterns representative of a leg loop or a pair of leg loops. The weft strips and the warp strips form longitudinal strips and transverse strips or vice versa. The weft strips and the warp strips have been defined concerning the dimensions and the mechanical properties so as to form a woven layer with specific mechanical properties. The woven band is cut to position the weft strips and the warp strips in the expected positions for the transverse and longitudinal strips, or vice versa.

As the loom offers great freedom in the way the weft strips and the warp strips are formed, it is even possible to form both leg loops using the same woven band. The woven band can comprise one or more patterns representative of a belt 1 and/or one or more patterns representative of a leg loop 2 or a pair of leg loops 2. The motifs can be arranged one behind the other in the weft or warp direction.

As illustrated in FIG. 7, a single woven band can contain belt patterns having different dimensions to form belts 1 suitable for users of different builds. The same can be the case for the leg loops 2.

As the woven band is woven on a loom, particularly a Jacquard loom, the shapes of the zones are free, enabling a woven band to be formed in a single loom operation, with patterns that are better suited to the formation of several patterns representative of a waistband and/or leg loop, thus limiting waste compared with the manufacture of a strap.

Cutting of the woven band is performed with respect to a reference made in the woven band so as to form the woven layer 3 with the areas of the woven band that correspond to the areas of the woven layer with different technical characteristics.

1. Roping harness comprising a belt, a pair of leg loops, a woven layer in the form of a ring to form either the belt or one of the leg loops, and a closure fixed to a first end and to an opposite second end of the woven layer to close the ring;
wherein the woven layer comprises first yarns and second yarns woven together to form a weave extending continuously from the first end to the opposite second end in a first direction, the first yarns extending continuously from the first end to the second end to provide a mechanical strength of the ring whereas the second yarns extend in a second direction;
wherein the woven layer presents a broad portion having a larger width than a narrow portion, the broad portion and the narrow portion being offset in the first direction, the width being measured in the second direction;
wherein the woven layer has at least one fold defining a fold line extending mainly in the first direction and comprising a component in the second direction to form the narrow portion, the fold comprising a support portion and an overlap portion folded onto the support portion, the support portion and the overlap portion being separated by the folding line;
wherein the overlap portion and the support portion have several common first yarns and several common second yarns and in that the broad portion and narrow portion have an identical number of first yarns.

2. Roping harness according to claim 1 wherein the overlap portion and the support portion have common first yarns.

3. Roping harness according to claim 1 wherein the belt or the leg loop has a thicker first end than a central area, the central area being arranged between the opposite first and second ends in the first direction, the thickness being measured perpendicularly to the first direction and to the second direction, the belt and the leg loop having an inner face designed to be in contact with the user and an opposite outer face.

4. Roping harness according to claim 1 wherein the fold line defines an angle of less than 30° with respect to the first direction.

5. Roping harness according to claim 1 wherein the overlap portion covers at least 50% of the width of the support portion, the width extending from the first edge to the second edge.

6. Roping harness according to claim 5 wherein the overlap portion covers 100% of the width of the support portion.

7. Roping harness according to claim 1 wherein the first yarns of the overlap portion and the first yarns of the support portion are misaligned.

8. Roping harness according to claim 7 wherein the narrow portion has at least one seam fixing the misalignment between the first yarns.

9. Roping harness according to claim 1 wherein the closure is chosen from an adjustment system connected to the first and second ends of the woven layer and configured to close and adjust the circumference of said ring, or an opening-closing system connected to the two ends of the woven layer and configured to open and close the ring.

10. Roping harness according to claim 9 wherein the closure is an adjustment system comprising a first webbing part and a second buckle part, the first webbing part comprising a strap designed to be inserted in a buckle of the second buckle part and wherein the narrow portion forms the strap, the first yarns being inserted in the buckle.

11. Roping harness according to claim 9 wherein the closure is an adjustment system comprising a first webbing part and a second buckle part, the first webbing part comprising a strap designed to be inserted in a buckle of the second buckle part and wherein the narrow portion forms a wire element attaching the buckle, the first yarns passing round a portion of the buckle to attach the buckle to the woven layer.

12. Method for manufacturing a roping harness comprising the following steps:
providing a woven band that comprises first yarns woven with second yarns to form a weave, the first yarns extending in a first direction, the second yarns extending in a second direction, the woven band presenting a thickness;
cutting the woven band to a predefined shape to define a woven layer designed to form a belt or a leg loop of the roping harness, the weave extending continuously from a first end to a second end in the first direction and from a first edge to a second edge in the second direction, each first yarn extending continuously in the first direction from the first end to the second end to achieve a mechanical continuity, the second yarns extending continuously from the first edge to the second edge, wherein each second yarn connects all the first yarns mechanically in the second direction;
folding only a part of the woven layer so as to form a broad portion and a narrow portion having an identical number of first yarns, the broad portion and the narrow portion being woven and offset in the first direction, the width being measured in the second direction, the narrow portion being obtained by folding with at least one fold line extending mainly in the first direction and comprising a component in the second direction, the narrow portion having at least two thicknesses of the woven layer, the two thicknesses of the woven layer being mechanically joined by a continuity of first yarns and second yarns;
forming a closure at the first end and at the second end to close the ring.

13. Method according to claim 12 wherein forming the closure involves forming an adjustment system comprising a first webbing part and a second buckle part respectively arranged at the first end and the second ends of the woven layer and configured to adjust the circumference of said either the belt or a leg loop, each first yarn extending continuously in the first direction from the first webbing part to the second buckle part to achieve a mechanical continuity, and wherein the first yarns of two thicknesses of the narrow portion extend up to the first webbing part.
